(19) United States
(12) Patent Application Publication
(10) Pub. No.: US 2017/0048815 A1
(43) Pub. Date: Feb. 16, 2017

(54) Location Awareness to Packet Flows using Network Service Headers

(71) Applicant: Cisco Technology, Inc., San Jose, CA (US)

(72) Inventors: Joseph M. Clarke, Raleigh, NC (US); Carlos M. Pignataro, Raleigh, NC (US); Gonzalo Salgueiro, Raleigh, NC (US); James N. Guichard, New Boston, NH (US)

(21) Appl. No.: 14/824,313

(22) Filed: Aug. 12, 2015

(51) Int. Cl. H04W 64/00; H04W 4/02

(52) U.S. Cl. CPC H04W 64/00; H04W 4/02

(57) ABSTRACT

A classifier network device in a service function chain receives a data packet from a first computing device. The classifier network device generates an encapsulated packet for the service function chain by encapsulating the data packet with a network service header. The network service header includes at least one metadata header. The classifier network device determines a location of the first computing device and writes location information corresponding to the location of the first computing device in the metadata header.

### TECHNICAL FIELD

The present disclosure relates to applying service function chains in networks.

### BACKGROUND

Service Function Chaining enables virtualized networking functions to be implemented as part of a cloud network. A Service Function Chain defines an ordered list of a plurality of service functions (e.g., firewall, compression, intrusion detection/prevention, load balancing, etc.) that may be applied to packet flows in the network. A flow enters the network through a classifier node that generates a Service Function Path for that flow according to the Service Function Chain policy. The classifier node encapsulates each packet of the flow with a Network Service Header that indicates the service functions to which the flow will be subjected, and the order the service functions will be applied.

Service Function Chaining and Network Service Headers provide a scalable, extensible, and standardized way of sharing metadata between both network nodes and service nodes within a network topology. This allows for disparate nodes that require shared context, but do not communicate directly, to share that context via metadata with the packets traversing the network or service topology.

### BRIEF DESCRIPTION OF THE DRAWINGS

FIG. 1 is a system block diagram showing a Service Function Chain network environment spanning a plurality of locations according to an example embodiment.

FIG. 2 is a simplified block diagram of a data center within the Service Function Chain network environment according to an example embodiment.

FIG. 3 is a simplified block diagram of a network device according to an example embodiment.

FIG. 4 is a system block diagram showing a classifier node determining a Service Function Path based on location information according to an example embodiment.

FIG. 5 is a flowchart showing the operations of a classifier network device encapsulating a flow with a Network Service Header including location information according to an example embodiment.

### DESCRIPTION OF EXAMPLE EMBODIMENTS

### Overview

A classifier network device in a service function chain receives a data packet from a first computing device. The classifier network device generates an encapsulated packet for the service function chain by encapsulating the data packet with a network service header. The network service header includes at least one metadata header. The classifier network device determines a location of the first computing device and writes location information corresponding to the location of the first computing device in the metadata header.

### EXAMPLE EMBODIMENTS

There is a desire in some networks/organizations to track and/or limit conversations or traffic flows based on the physical location of the client and server. For example, cyber attacks may originate from specific countries which would normally not need to communicate with certain networks or hosts. It may provide a valuable service to be able to track and potentially limit all traffic to and/or from such countries. Additionally, certain countries or geographic regions may require that specific traffic be contained within certain geographic boundaries.

Similarly, video services and cloud-based digital video recording services (as well as some aspects of unified communications) in which video distribution may need to adhere to geographic regulations may benefit from geolocation data at the service layer. More specific location data may be passed from clients to content providers in order to provide targeted advertising, promotional materials, and/or public service announcements.

Location-aware services (e.g., firewall, load balancing, video caching, etc.) may be enhanced to leverage location as metadata to a flow or packet. The techniques provided herein describe tagging traffic flows with civic location (e.g., street address, building name, postal code, community name, etc.) and/or geolocation (e.g., Global Positioning Satellite data or other satellite positioning data, cellular tower triangulation/location data) at the service layer in a scalable and reliable manner.

By including location data within a Service Function Chaining framework, additional value may be delivered to networks including: geolocation-based security policy enforcement (e.g., policing flows between locations, dropping flows from/to unauthorized locations, etc.), asserting data sovereignty, ensuring that all services are location-aware such that packets and flows in motion stay within a geographical boundary, applying location-based traffic policies (e.g., routing, classification, application-specific, etc.), leveraging civic location to provide location-aware data to a variety of applications/services (e.g., location targeted advertisements, public service announcements, video/entertainment, etc.), displaying location-relevant information, and optimizing performance of location-aware applications.

The techniques presented herein enable a variety of location data to be extracted from packets and transmitted using the Network Service Header between service and network elements in a service path. Geolocation (e.g., country code, etc.) of a packet's source address may be used to enforce policies (e.g., security, traffic routing, classification, application-specific, etc.). In one example, a security policy may be enforces if there is a “hostile” country that would otherwise have no reason to communicate with a network. The security administrator may have a Service Function Chain classifier extract geolocation data from the packet's source address on ingress, then drop packets that originate from undesirable locations. The packets may be dropped at the classifier or at a service function within the service chain.

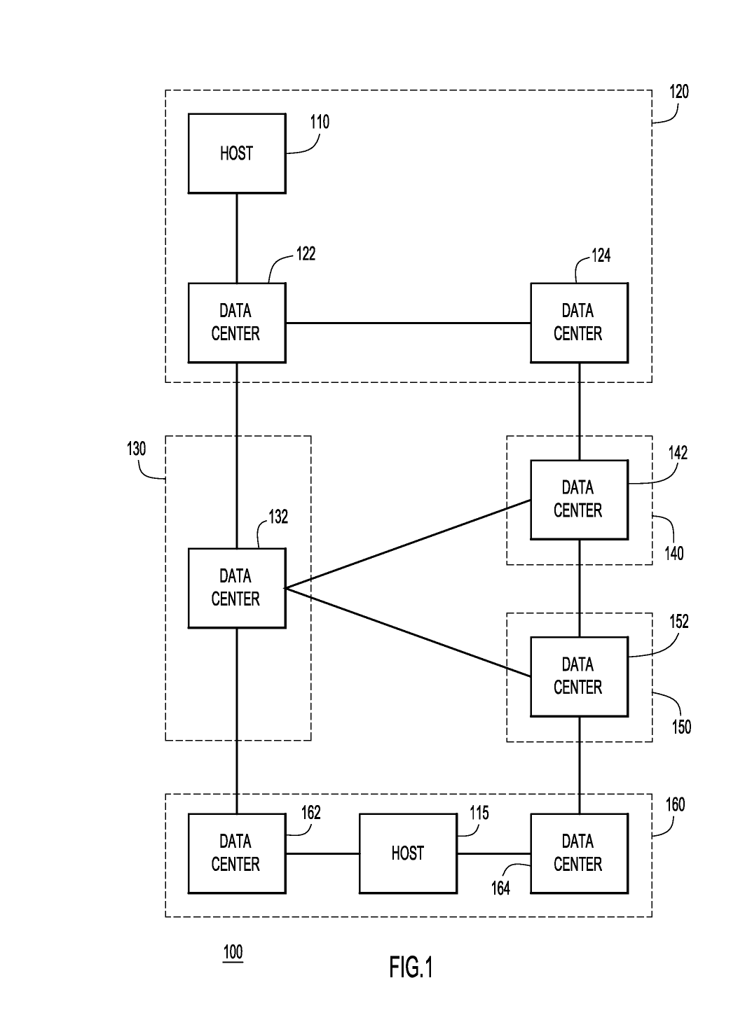

Referring now to FIG. 1, a simplified block diagram of a location-aware Service Function Chaining system 100 is shown. System 100 includes a host 110 configured to communicate with a host 115 through a plurality of data centers located in a plurality of locations. Host 110 is located within the boundaries of a location 120, and communicates with data center 122, which is also within the boundaries of location 120. Data center 124 is coupled to data center 122, and is also located within the boundaries of location 120. Data centers 132, 142, and 152 are located within the boundaries of locations 130, 140, and 150, respectively. Location 160 includes data centers 162 and 164, which are coupled to the host 115. The data centers 122, 124, 132, 142, 152, 162, and 164 may communicate with one or more other the other data centers through network links.

In one example, the locations 120, 130, 140, 150, and 160 may be groups of countries (e.g., the European Union), individual countries, states within one or more countries, cities, communities, buildings, and/or rooms within one or more buildings. Each location may include one or more data centers that are connected to other data centers in the same or different locations to form a computer network connecting a plurality of hosts.

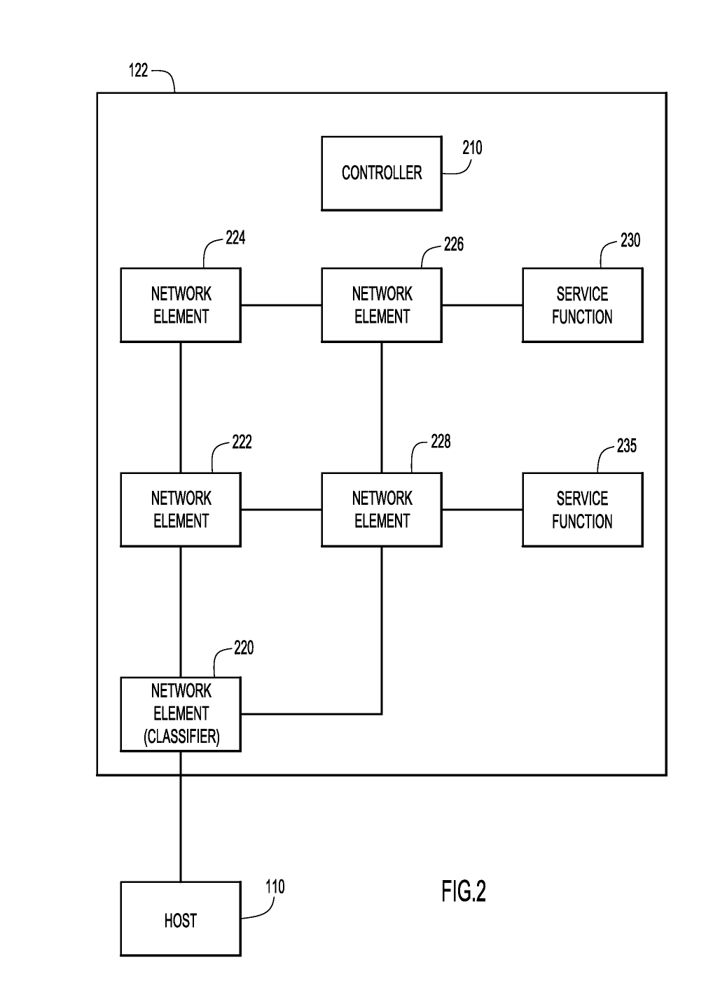

Referring now to FIG. 2, a simplified block diagram of the data center 122 is shown coupled to the host 110. The other data centers shown in FIG. 1 may generally include similar elements as described hereinafter in data center 122. The data center 122 includes a controller 210 to monitor and control the operations of the data center 122. Network elements 220, 222, 224, 226, and 228 route network traffic throughout the data center 122. Service functions 230 and 235 are coupled to network elements 226 and 228, respectively. The service functions 230 and 235 may provide services, such as a firewall service, load balancing, compression, and network address translation to traffic flows that pass through their respective network elements 226 and 228. Other data centers may include similar or different service functions to the data center 122, and a data flow may be subject to service functions provided from one or more data centers.

Host 110 is connected to the data center 122 through network element 220, which acts as a classifier for traffic entering the computer network described herein. The classifier network element 220 encapsulates each packet of a traffic flow with a Network Service Header. The Network Service Header includes data describing a Service Function Path that the packet will travel within the network in order to receive the appropriate service functions. The Service Function Path determines which service functions will operate on the packet as well as the order in which the service functions will operate on the packet. The classifier will also insert a location tag into the metadata of the Network Service Header corresponding to the location of the source of the packet/flow, e.g., host 110. The classifier network element 220 may also insert a location tag corresponding to the destination of the packet/flow, e.g., host 115. The metadata may comprise a series of fixed length metadata headers (e.g., Type 1 Network Service Header) or one or more variable length metadata headers (e.g., Type 2 Network Service Header). The Network Service Header may be encrypted to add a layer of protection and ensure that the location information is securely transported such that it cannot be altered or bypassed.

In one example, network elements 220, 222, 224, 226, and 228 may be, for example, a switch or router in a variety of types of networks (e.g., any combination of Internet, intranet, local area network (LAN), wide area network (WAN), wired network, wireless network, etc.) that connects computing devices. Hosts 110 and 115 may be computing devices, e.g., desktop computer, laptop computer, server, virtual machine on a hypervisor, tablet computer, tablet, smart phone, etc., that communicate through the network elements within the data centers.

In another example, the controller 210 may communicate the location information to the classifier network element 220. The controller 210 may determine the location of the hosts 110 and 115 by translating the Internet Protocol (IP) addresses of the source and destination into corresponding geographical tags, such as country codes. Country codes may be encoded into two bytes and inserted into either Type 1 or Type 2 Network Service Headers by the classifier network element 220. Alternatively, the classifier network element 220 may determine the location information without input from the controller 210.

If richer context than country codes is required (e.g., country names, street addresses, satellite positioning data), then Type 2 Network Service Headers may be used to encode variable length parameters. In one example, for a localized event (e.g., convention, concert, etc.) the richer context may comprise a name for the event or venue. Advertising services may leverage the knowledge that the source host is in a particular event to customize advertisements and promotional material to event attendees.

In addition to simply blocking traffic from undesirable locations, security administrators can ensure against loss of data sovereignty by preventing certain traffic flows from traversing country boundaries. For example, an administrator could assert that all traffic from a particular application must flow between hosts in the same country, and the traffic must not leave the country boundaries, leveraging the Service Function Path enhanced with location information ensures not only that the server and data center are in a particular country, but also that the packet/flow does not cross the country boundary. The data is not only stored in the country, but data in motion flows are also maintained within a country's boundaries.

In a further example, the location of the source host 110 may be private and not able to be determined by the classifier network element 220 or the controller 210. If the location of the source host 110 may not be determined, then the location of the closest network element with a known location (e.g., the classifier network element 220) may be used as the source location. Using a location as close to the source as possible ensures that any other packet transformation operations, such as Network Address Translation, happen after determining the location and inserting the location into the Network Service Header. By determining the location at the provider edge (e.g., the classifier network element 220), the origination location of a packet may be determined and retained within the Network Service Header even if the provider later sends the flow through a Carrier Grade Network Address Translation gateway.

The classifier network element 220 may apply a location-based policy in determining the Service Function Path to apply to a particular packet. In one example, the classifier 220 may direct a packet to a service function in a particular data center based on a policy that dictates that the service function should be performed in a particular location. In another example, the classifier 220 may create a Service Function Path that directs the packet to avoid traversing a particular data center due to a policy restricting network traffic from a particular location.

Once the location information is inserted into the Network Service Header, the packet may be sent to the first service function in the Service Function Path, which may use the location information to determine how to perform the service function. In one example, the service function may be a firewall that blocks all traffic to and/or from a specific country. In a further example, the service function may be a video service that adapts the format of the video to adhere to specific formatting used in the destination location.

In another example, an individual network element may use locally configured location data in the Network Service Header. Some routers and switches may be configured with both civic locations and geolocations for the network element, as well as per-interface civic locations and geolocations. This would enable a provider's customer premises equipment to tag packets coming from a specific user with that user's postal code. This data may be used by other service to enable location-aware services and applications (e.g., video), targeted advertising and/or public service announcements in network data streams. A location-based policy on the network element may also enable location-aware captive portals, which may change dynamically base don the location of the user coming to the portal.

In a further example, host devices and network devices may include satellite location hardware or cellular triangulation hardware to determine a precise geolocation of the device. This geolocation information may be inserted into any packet that traverses the device. This allows optimizing performance for location-aware applications.

FIGS. 1 and 2 show a specific number of hosts, data centers, network elements, and service functions. However, the Service Function Chain system 100 may comprise any number of data centers with any number of network elements and service functions providing services to any number of hosts using the techniques described herein.

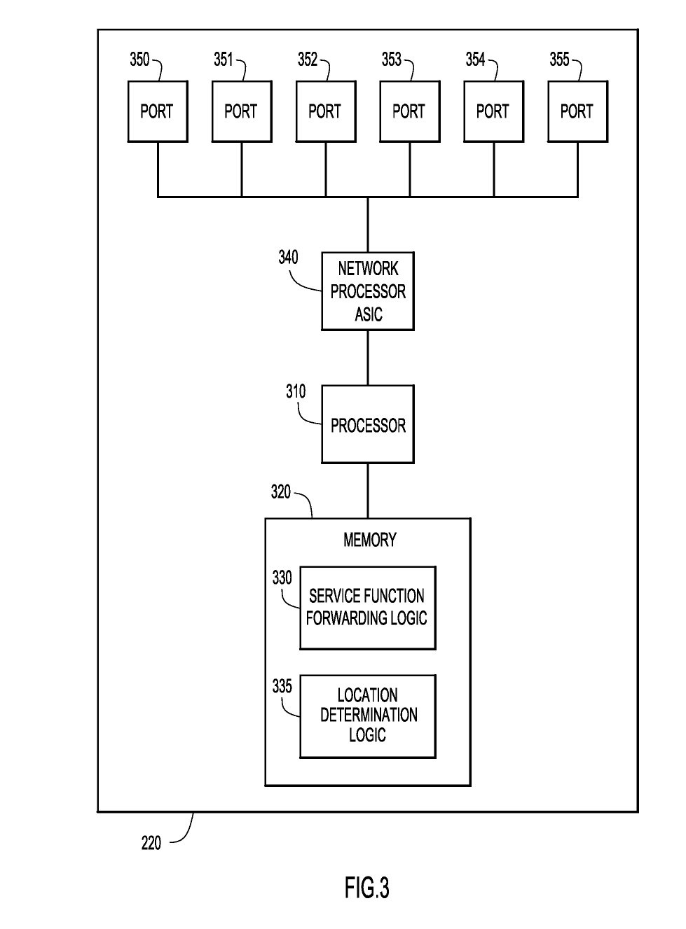

Referring now to FIG. 3, a simplified block diagram of a network device 220 configured to perform the techniques presented herein is shown. Network device 220 is used as an example, and network devices 222, 224, 226, 228 may have similar configurations, as may any of the network elements in other data centers. Network device 220 includes, among other possible components, a processor 310 to process instructions relevant to processing communication packets in a location-aware Service Function Chain, and memory 320 to store a variety of data and software instructions (e.g., Service Function Forwarding logic 330, Location Determination logic 335, communication packets, etc.). The network device 220 also includes a network processor application specific integrated circuit (ASIC) 340 to process communication packets that flow through the network element 220. Network processor ASIC 340 processes communication packets be sent to and received from ports 350, 351, 352, 353, 354, and 355. While only six ports are shown in this example, any number of ports may be included in network element 220.

Memory 320 may include read only memory (ROM), random access memory (RAM), magnetic disk storage media devices, optical storage media devices, flash memory devices, electrical, optical, or other physical/tangible (e.g., non-transitory) memory storage devices. The processor 310 is, for example, a microprocessor or microcontroller that executes instructions for implementing the processes described herein. Thus, in general, the memory 320 may comprise one or more tangible (non-transitory) computer readable storage media (e.g., a memory device) encoded with software comprising computer executable instructions and when the software is executed (e.g., by the processor 310) it is operable to perform the operations described herein.

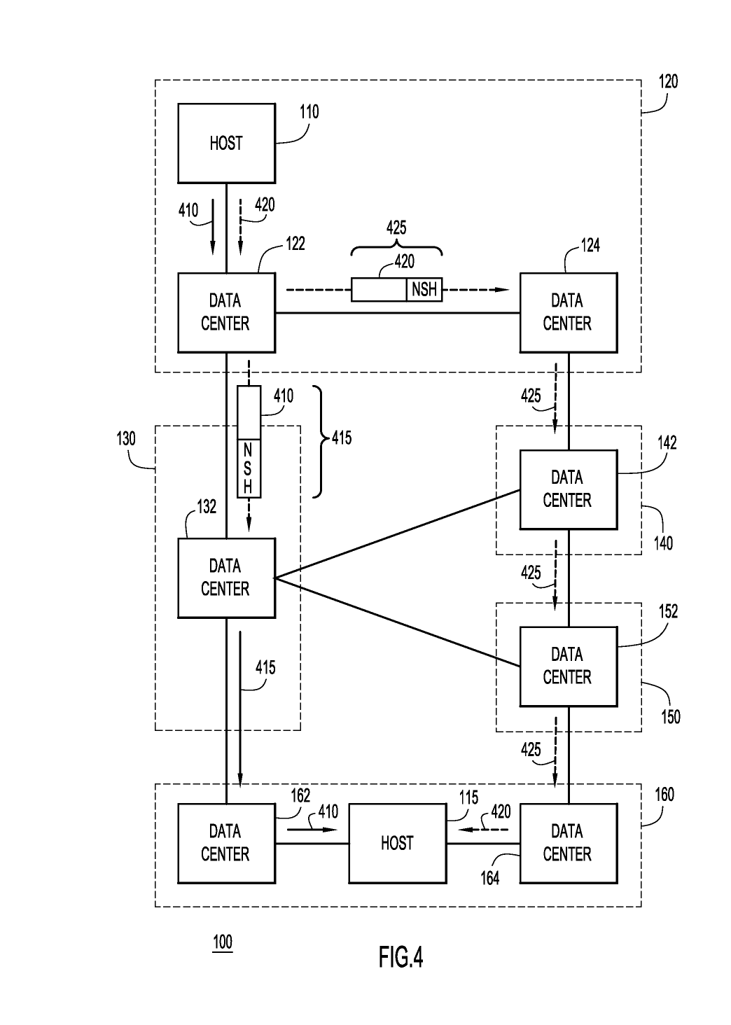

Referring now to FIG. 4, a simplified system block diagram shows packets being routed from host 110 to host 115 based on the location of the host devices and a location-based policy. The host 110 sends a packet 410 directed toward host 115. The packet 410 enters the network through data center 122, which encapsulates the packet 410 with a Network Service Header. The Network Service Header may include various identifying information about the packet 410, such as the application responsible for the packet 410, the location of the source host 110, and/or the location of the destination host 115. The data center 122 determines that a location-based policy will apply to the packet 410 and creates a Service Function Path that traverses data centers 132 and 162. The data center 122 sends the encapsulated packet 415 along the Service Function Path, which may include one or more service functions specified to be performed in the data center 122. After any applicable service functions are performed in data center 122, the encapsulated packet 415 is forwarded to data center 132, where additional service functions specified in the Service Function Path may be performed. The data center 132 forwards the encapsulated packet 415 to the data center 162, where further service functions may be performed before removing the encapsulation and sending the packet 410 to the destination host 115.

The source host 110 also sends a packet 420 directed toward host 115. The packet 420 also enters the network through data center 122, which encapsulates the packet 420 with a Network Service Header. In contrast the packet 410, the classifier network element in the data center 122 includes a policy that prevents the packet 410 from entering the location 130. To uphold the location-based policy, the data center 122 creates a Service Function Path that avoids data center 132, due to its presence in location 130. The Service Function Path sends the encapsulated packet 425 along a path from the data center 122 to the data center 124, followed by the data center 142, the data center 152, and the data center 164. The data center 164 removes the encapsulation and sends packet 420 to the destination host 115.

In one example, the location 120 of host 110 is in China, the location 160 of host 115 is in the United States, and the location 130 is in Russia. The source IP address of the packet 420 may be translated (e.g., with a geoiplookup tool) to “CN,” and the destination IP address may be translated to “US.” The value of CN may be encoded as a hexadecimal value of [0x43 0x4E], and the value of US may be encoded as [0x55 0x53]. The resulting NSH Type 1 header metadata would be:

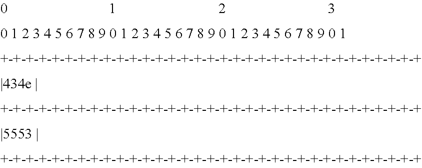

These encoded values may be inserted into the Network Service Header metadata of the encapsulated packet 425. If a location-based policy requires that network traffic from China to the US must not pass through Russia, then the Service Function Path for encapsulated packet 425 would ensure that it does not get routed to data center 132 in location 130.

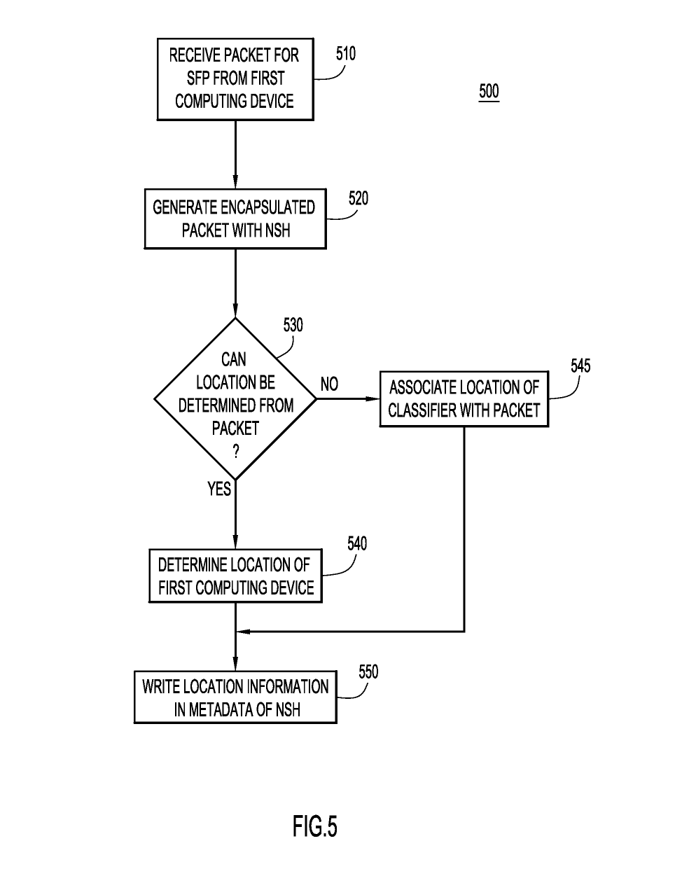

Referring now to FIG. 5, a flowchart is shown for a process 500 by which a classifier network element inserts location information into the Network Service Header according to one example. In step 510, the classifier receives a packet from a first computing device, such as a source host device. The packet is subject to a Service Function Path, which specifies one or more service functions that will act on the packet. In step 520, the classifier generates an encapsulated packet by encapsulating the received packet with a Network Service Header. If the location of the first computing device can be determined from the packet itself (e.g., based on the IP address), as determined in step 530, then the classifier determines the location of the first computing device in step 540. Otherwise, the classifier associates the packet with the location of the classifier device in step 545. In step 550, the classifier device inserts the location information associated with the packet into the Network Service Header. The Network Service Header also identifies the Service Function Path that the encapsulated packet will use, which may be based on location-aware policies.

The references to physical network devices are not meant to be limiting. For example, the network devices shown in FIGS. 2 and 3 may be software-based devices running in a virtualized manner. Likewise, the hosts shown in the accompanying figures may be virtual machine processes.

In summary, the techniques described herein provide for a mechanism whereby a variety of location-related data is added as metadata to packet flows by employing Service Function Chaining and Network Service Headers. The location data may be extracted and added to the packet flows, and acted upon by various network and service functions. The location data may include source and destination IP geolocation, device and interface civic and/or geolocation, device satellite positioning location data, and/or cellular network tower triangulation location data. The actions performed may include, but are not limited to, geolocation-based security policy enforcement (e.g., policing flows between locations, dropping flows from unauthorized locations, etc.), applying location-based traffic policies (e.g., routing classification, application-specific, etc.) on global networks, leveraging civic location to provide location-aware data to a variety of applications/services (e.g., location targeted advertisements, public service announcements, video/entertainment, etc.). The inclusion of location data in the Network Service Header at the service layer ensures that all services are location-aware, and the geographic location of the packets and flows can be constrained both in storing the packets and while the flows are in motion.

In one form, the techniques presented herein provide for a computer-implemented method performed at a classifier network device in a service function chain, the method including receiving a data packet from a first computing device. The classifier network device generates an encapsulated packet for the service function chain by encapsulating the data packet with a network service header. The network service header includes at least one metadata header. The classifier network device determines a location of the first computing device and writes (inserts, adds, etc.) location information corresponding to (i.e., indicating) the location of the first computing device in the metadata header.

In another form, the techniques presented herein provide for an apparatus comprising a network interface unit and a processor. The network interface unit is configured to communicate with a plurality of network devices in a service function chain and a first computing device. The processor is configured to receive a data packet for the service function chain from the first computing device. The processor is configured to generate an encapsulated packet for the service function chain by encapsulating the data packet with a network service header. The network service header includes at least one metadata header. The processor is configured to determine a location of the first computing device and write location information in the metadata header. The location information corresponds to the location of the first computing device.

In yet another form, the techniques presented herein provide for a non-transitory computer readable storage media encoded with software comprising computer executable instructions. When the software is executed, the instructions are operable to cause a processor to receive a data packet for a service function chain from a first computing device. The instructions cause the processor to generate an encapsulated packet for the service function chain by encapsulating the data packet with a network service header. The network service header includes at least one metadata header. The instructions cause the processor to determine a location of the first computing device and write location information in the metadata header. The location information corresponds to the location of the first computing device.

These techniques are useful to all network operators. For enterprises, these techniques can be used to ensure data sovereignty and prevent unauthorized locations from communicating with the network. For service providers, this can be used to provide data enrichment to upstream providers, targeted location-based segmentation/prioritization, or even to their own content services.

The above description is intended by way of example only. Various modifications and structural changes may be made therein without departing from the scope of the concepts described herein and within the scope and range of equivalents of the claims.

What is claimed is:

1. A method comprising:
receiving at a classifier network device in a service function chain, a data packet from a first computing device;
generating an encapsulated packet for the service function chain by encapsulating the data packet with a network service header, the network service header including at least one metadata header;
determining a location of the first computing device; and
writing location information in the metadata header, the location information corresponding to the location of the first computing device.

2. The method of claim 1, further comprising:
determining a location-based policy for the service function chain; and
sending the encapsulated packet to receive a first service function according to the location-based policy.

3. The method of claim 2, wherein the location-based policy determines a plurality of service functions the encapsulated packet will receive based on the location information in the metadata header.

4. The method of claim 1, wherein the at least one metadata header includes one or more variable length metadata headers.

5. The method of claim 1, wherein the location information comprises satellite positioning system coordinates or cellular network triangulation data.

6. The method of claim 1, wherein the location of the first computing device comprises a civic location, and the location information comprises a street address, a postal code, a community name, or a building location.

7. The method of claim 1, further comprising writing additional location information in the metadata header, the additional location information corresponding to a location of a destination of the data packet.

8. An apparatus comprising:
a network interface unit configured to communicate with a plurality of network devices in a service function chain and a first computing device;
a processor configured to:
receive a data packet for the service function chain from the first computing device via the network interface unit;
generate an encapsulated packet for the service function chain by encapsulating the data packet with a network service header, the network service header including at least one metadata header;
determine a location of the first computing device; and
write location information in the metadata header, the location information corresponding to the location of the first computing device.

9. The apparatus of claim 8, wherein the processor is further configured to:
determine a location-based policy for the service function chain; and
send the encapsulated packet via the network interface unit to receive a first service function according to the location-based policy.

10. The apparatus of claim 9, wherein the location-based policy determines a plurality of service functions the encapsulated packet will receive based on the location information in the metadata header.

11. The apparatus of claim 8, wherein the at least one metadata header includes one or more variable length metadata headers.

12. The apparatus of claim 8, wherein the location information comprises satellite positioning system coordinates or cellular network triangulation data.

13. The apparatus of claim 8, wherein the location of the first computing device comprises a civic location, and the location information comprises a street address, a postal code, a community name, or a building location.

14. The apparatus of claim 8, wherein the processor is configured to write additional location information in the metadata header, the additional location information corresponding to a location of a destination of the data packet.

15. One or more non-transitory computer readable storage media encoded with software comprising computer executable instructions and when the software is executed operable to cause a processor to:
receive a data packet for a service function chain from a first computing device;
generate an encapsulated packet for the service function chain by encapsulating the data packet with a network service header, the network service header including at least one metadata header;
determine a location of the first computing device; and
write location information in the metadata header, the location information corresponding to the location of the first computing device.

16. The computer readable storage media of claim 15, further comprising instructions operable to cause the processor to:
determine a location-based policy for the service function chain; and
send the encapsulated packet to receive a first service function according to the location-based policy.

17. The computer readable storage media of claim 16, wherein the location-based policy determines a plurality of service functions the encapsulated packet will receive based on the location information in the metadata header.

18. The computer readable storage media of claim 15, wherein the at least one metadata header includes one or more variable length metadata headers.

19. The computer readable storage media of claim 15, wherein the location information comprises satellite positioning system coordinates or cellular network triangulation data.

20. The computer readable storage media of claim 15, wherein the location of the first computing device comprises a civic location, and the location information comprises a street address, a postal code, a community name, or a building location.
